(19) United States
(12) Patent Application Publication
(10) Pub. No.: US 2019/0218928 A1
(43) Pub. Date: Jul. 18, 2019

(54) BLADE OUTER AIR SEAL FOR GAS TURBINE ENGINE

(71) Applicant: United Technologies Corporation, Farmington, CT (US)

(72) Inventors: Christina G. Ciamarra, Kittery, ME (US); Brian Barainca, Kennebunk, ME (US); Thurman Carlo Dabbs, Dover, NH (US)

(21) Appl. No.: 15/873,496

(22) Filed: Jan. 17, 2018

(51) Int. Cl. F01D 11/10

(52) U.S. Cl. CPC F01D 11/10; F05D 2260/96; F05D 2260/30; F05D 2240/55

(57) ABSTRACT

An assembly for use in a turbine section of a gas turbine engine, the assembly including: a blade outer air seal having a forward end and opposite aft end and a pair of opposing sides extending between the forward end and the opposite aft end; a blade outer air seal support, the blade outer air seal support having a rail with at least one scalloped opening, the rail engaging a hook located at the forward end of the blade outer air seal when the blade outer air seal is secured to the blade outer air seal support, wherein two points of contact are made between the hook and the rail of the blade outer air seal support when the blade outer air seal is secured to the blade outer air seal support; and a vane platform, that receives and supports a rail of the blade outer air seal, the rail being located at the aft end of the blade outer air seal and the rail extends continuously between the pair of opposing sides of the blade outer air seal, wherein a single point of contact is made between the rail of the blade outer air seal and the vane platform when the blade outer air seal is secured to the vane platform.

### BACKGROUND

The present disclosure relates to blade outer air seals (BOAS) for gas turbine engines and more particularly, configurations and methods for securing the BOAS to the gas turbine engine.

A gas turbine engine typically includes a fan section, a compressor section, a combustor section and a turbine section. Air entering the compressor section is compressed and delivered into the combustion section where it is mixed with fuel and ignited to generate a high-energy exhaust gas flow. The high-energy exhaust gas flow expands through the turbine section to drive the compressor and the fan section. The compressor section typically includes low and high pressure compressors, and the turbine section includes low and high pressure turbines.

Both the compressor and turbine sections include rotating blades alternating between stationary vanes. The vanes and rotating blades in the turbine section extend into the flow path of the high-energy exhaust gas flow. Leakage around vanes and blades reduces efficiency of the turbine section. Blade outer air seals (BOAS) control leakage of gas flow and improve engine efficiency. All structures within the exhaust gas flow path are exposed to the extreme temperatures. A cooling air flow is therefore utilized over some structures to improve durability and performance.

As such blade outer air seals (BOAS) may be disposed in turbine sections of turbomachines for sealing the gap between a turbine blade tip and the inner wall of the turbomachine casing. In such uses, the BOAS can be exposed to extreme heat and require cooling.

Accordingly, it is desirable to provide BOAS suitable for use in such environments.

### BRIEF DESCRIPTION

In one embodiment, an assembly for use in a turbine section of a gas turbine engine is disclosed. The assembly including: a blade outer air seal having a forward end and opposite aft end and a pair of opposing sides extending between the forward end and the opposite aft end; a blade outer air seal support, the blade outer air seal support having a rail with at least one scalloped opening, the rail engaging a hook located at the forward end of the blade outer air seal when the blade outer air seal is secured to the blade outer air seal support, wherein two points of contact are made between the hook and the rail of the blade outer air seal support when the blade outer air seal is secured to the blade outer air seal support; and a vane platform, that receives and supports a rail of the blade outer air seal, the rail being located at the aft end of the blade outer air seal and the rail extends continuously between the pair of opposing sides of the blade outer air seal, wherein a single point of contact is made between the rail of the blade outer air seal and the vane platform when the blade outer air seal is secured to the vane platform.

In addition to one or more of the features described above, or as an alternative to any of the foregoing embodiments, the blade outer air seal support has a plurality of hook features that engage complimentary features of a turbine case.

In addition to one or more of the features described above, or as an alternative to any of the foregoing embodiments, the rail of the blade outer air seal support has a pair of scalloped features and is configured to support at least two blade outer air seals side by side.

In addition to one or more of the features described above, or as an alternative to any of the foregoing embodiments, the blade outer air seal has a pair of ears located proximate to the pair of opposing sides of the blade outer air seal.

In addition to one or more of the features described above, or as an alternative to any of the foregoing embodiments, the blade outer air seal has a pair of gussets to support the pair of ears and reduce vibrations in the blade outer air seal.

In addition to one or more of the features described above, or as an alternative to any of the foregoing embodiments, the blade outer air seal has a feature extending from the pair of gussets.

In addition to one or more of the features described above, or as an alternative to any of the foregoing embodiments, the blade outer air seal has a locating feature for aligning the blade outer air seal with a lug of the vane platform.

In addition to one or more of the features described above, or as an alternative to any of the foregoing embodiments, the blade outer air seal includes feather seals for receipt in grooves located on the pair of opposing sides of the blade outer air seal.

In addition to one or more of the features described above, or as an alternative to any of the foregoing embodiments, wherein one of the feather seals has a vertical portion that is received in a vertical groove of the grooves located on the pair of opposing sides of the blade outer air seal.

Also disclosed is a gas turbine engine having: a compressor section disposed about an axis; a combustor in fluid communication with the compressor section; a turbine section in fluid communication with the combustor, the turbine section includes at least one rotor having a plurality of rotating blades; and a plurality of assemblies circumferentially surrounding the rotating blades, wherein at least one of the plurality of assemblies includes: a blade outer air seal having a forward end and opposite aft end and a pair of opposing sides extending between the forward end and the opposite aft end; a blade outer air seal support, the blade outer air seal support having a rail with at least one scalloped opening, the rail engaging a hook located at the forward end of the blade outer air seal when the blade outer air seal is secured to the blade outer air seal support, wherein two points of contact are made between the hook and the rail of the blade outer air seal support when the blade outer air seal is secured to the blade outer air seal support; and a vane platform, that receives and supports a rail of the blade outer air seal, the rail being located at the aft end of the blade outer air seal and the rail extends continuously between the pair of opposing sides of the blade outer air seal, wherein a single point of contact is made between the rail of the blade outer air seal and the vane platform when the blade outer air seal is secured to the vane platform.

In addition to one or more of the features described above, or as an alternative to any of the foregoing embodiments, the blade outer air seal support has a plurality of hook features that engage complimentary features of a turbine case.

In addition to one or more of the features described above, or as an alternative to any of the foregoing embodiments, the rail of the blade outer air seal support has a pair of scalloped features and is configured to support at least two blade outer air seals side by side.

In addition to one or more of the features described above, or as an alternative to any of the foregoing embodiments, the blade outer air seal has a pair of ears located proximate to the pair of opposing sides of the blade outer air seal.

In addition to one or more of the features described above, or as an alternative to any of the foregoing embodiments, the blade outer air seal has a pair of gussets to support the pair of ears and reduce vibrations in the blade outer air seal.

In addition to one or more of the features described above, or as an alternative to any of the foregoing embodiments, the blade outer air seal has a feature extending from the pair of gussets, the feature being configured to interface with the blade outer air seal support when the blade outer air seal is secured to the blade outer air seal support.

In addition to one or more of the features described above, or as an alternative to any of the foregoing embodiments, the blade outer air seal has a locating feature for aligning the blade outer air seal with a lug of the vane platform.

In addition to one or more of the features described above, or as an alternative to any of the foregoing embodiments, the engine further includes feather seals for receipt in grooves located on the pair of opposing sides of the blade outer air seal.

In addition to one or more of the features described above, or as an alternative to any of the foregoing embodiments, wherein one of the feather seals has a vertical portion that is received in a vertical groove of the grooves located on the pair of opposing sides of the blade outer air seal.

Also disclosed herein is a method of supporting a blade outer air seal of a gas turbine engine. The method including the steps of: supporting a forward end of the blade outer air seal with a blade outer air seal support, the blade outer air seal support having a rail with at least one scalloped opening and the rail engages a hook located at the forward end of the blade outer air seal when the blade outer air seal is secured to the blade outer air seal support, wherein two points of contact are made between the hook of the blade outer air seal and the rail of the blade outer air seal support when the blade outer air seal is secured to the blade outer air seal support; and supporting an opposite aft end of the blade outer air seal with a vane platform, wherein the vane platform receives and supports a rail of the blade outer air seal, the rail being located on an aft end of the blade outer air seal and extends continuously between a pair of opposing sides of the blade outer air seal, wherein a single point contact is made between the rail of the blade outer air seal and the vane platform when the blade outer air seal is secured to the vane platform.

In addition to one or more of the features described above, or as an alternative to any of the foregoing embodiments, the method further includes the step of supporting the blade outer air seal support with a plurality of hook features that engage complimentary features of a turbine case.

### BRIEF DESCRIPTION OF THE DRAWINGS

The following descriptions should not be considered limiting in any way. With reference to the accompanying drawings, like elements are numbered alike:

FIG. 1 is a partial cross-sectional view of a gas turbine engine;

FIG. 2 is a cross-sectional view of a portion of the gas turbine engine;

FIG. 2A is an enlarged view of a portion of FIG. 2;

FIG. 3A is a perspective view of a blade outer air seals (BOAS) in accordance with an embodiment of the present disclosure;

FIG. 3B is a side view of a blade outer air seals (BOAS) in accordance with an embodiment of the present disclosure;

FIG. 3C is an aft view of a blade outer air seals (BOAS) in accordance with an embodiment of the present disclosure;

FIGS. 4A and 4B are perspective views of a blade outer air seal support in accordance with an embodiment of the present disclosure;

FIG. 5A is perspective view illustrating the blade outer air seal secured to the blade outer seal support in accordance with an embodiment of the present disclosure;

FIG. 5B is a view along lines 5B-5B of FIG. 5A;

FIG. 6 is perspective cross-sectional view of a blade outer air seal secured to a gas turbine engine;

FIG. 7 is a view along lines 7-7 of FIG. 6;

FIG. 8 is a perspective view of feather seals used in an embodiment of the present disclosure; and

FIG. 9 is a perspective view of a W seal used in an embodiment of the present disclosure.

### DETAILED DESCRIPTION

A detailed description of one or more embodiments of the disclosed apparatus and method are presented herein by way of exemplification and not limitation with reference to the Figures.

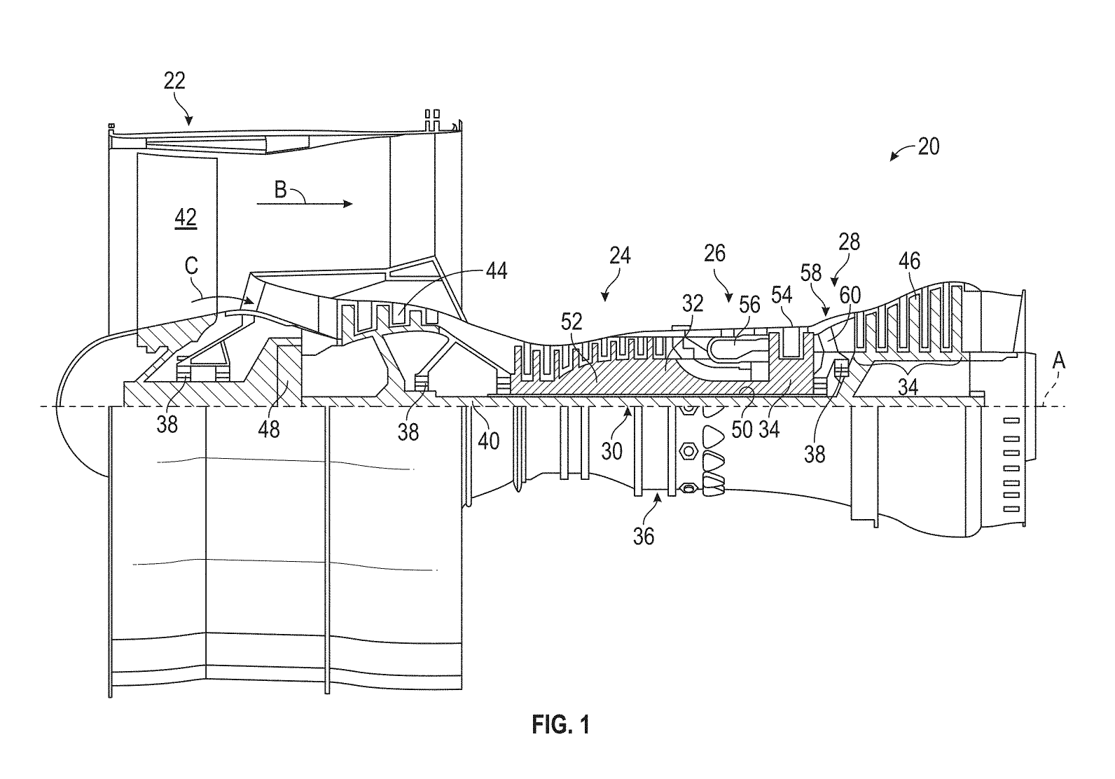

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption ('TSFC')”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram° R)/(518.7° R)]^{0.5}. The “Low corrected fan tip speed” as disclosed herein according to one non-limiting embodiment is less than about 1150 ft/second (350.5 m/sec).

The example gas turbine engine includes the fan 42 that comprises in one non-limiting embodiment less than about twenty-six (26) fan blades. In another non-limiting embodiment, the fan section 22 includes less than about twenty (20) fan blades. Moreover, in one disclosed embodiment the low pressure turbine 46 includes no more than about six (6) turbine rotors schematically indicated at 34. In another non-limiting example embodiment the low pressure turbine 46 includes about three (3) turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

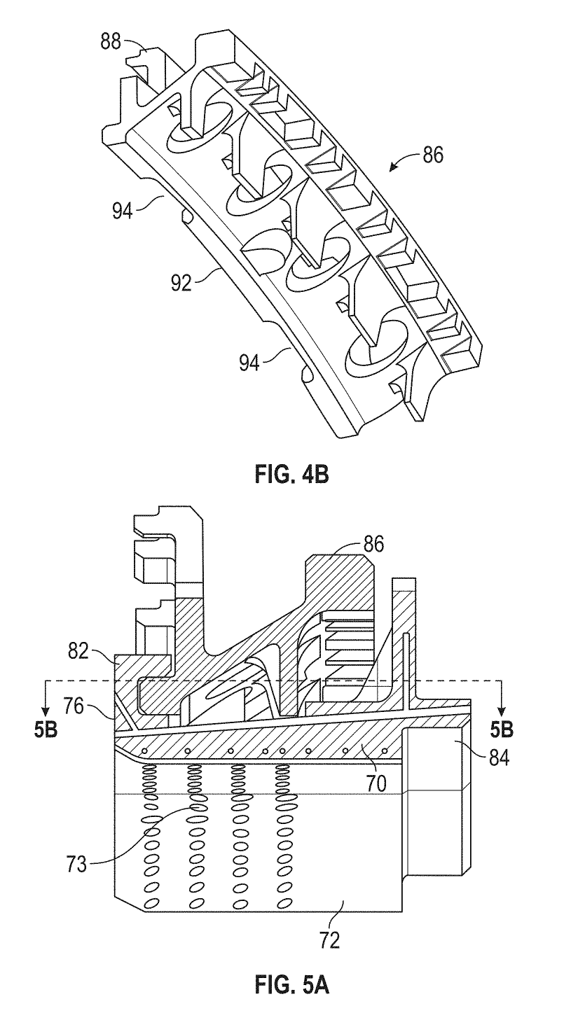

Referring to FIGS. 1-9, the example turbine section 28 includes at least one rotor 34 having a turbine blade 62. The turbine blade 62 includes a tip 65 disposed adjacent to a blade outer air seal 70 (BOAS). A stationary vane 67 is mounted and supported within a case 64 on at least one side of the turbine blade 62 for directing gas flow into the next turbine stage. The BOAS 70 is disposed adjacent to the tip 65 to provide a desired clearance between the tip 65 and a gas path surface 72 of the BOAS 70. The clearance provides for increase efficiency with regard to the extraction of energy from the high energy gas flow indicated by arrow 68.

The turbine blade 62 and vane 67 along with the blade outer air seal 70 are exposed to the high-energy exhaust gas flow 68 by for example from the combustor section 26. The high energy exhaust gas flow 68 is at an elevated temperature and thereby structures such as the blade 62, vane 67 and the BOAS 70 are fabricated from materials capable of withstanding the extremes in temperature. Moreover, each of these structures may include provisions for generating a cooling film air flow over the surfaces. The cooling film air flow generates a boundary layer that aids in survivability for the various structures within the path of the exhaust gasses 68.

In the disclosed example, a plurality of BOAS 70 are supported within the case 64 and abut each other to form a circumferential boundary radially outward of the tip 65. Accordingly, at least one stage of the turbine section 28 includes a plurality of BOAS 70 that define a radial clearance between the tip 65 and the gas path surface 72. Additional stages in the turbine section 28 will include additional BOAS to define the radial clearance with turbine blades of each stage.

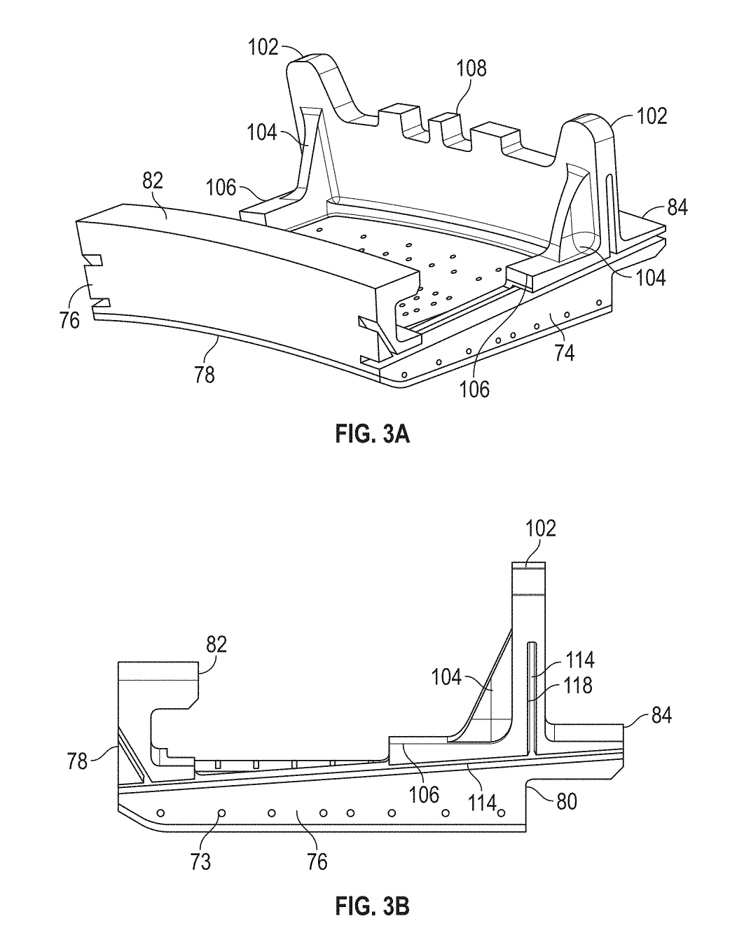

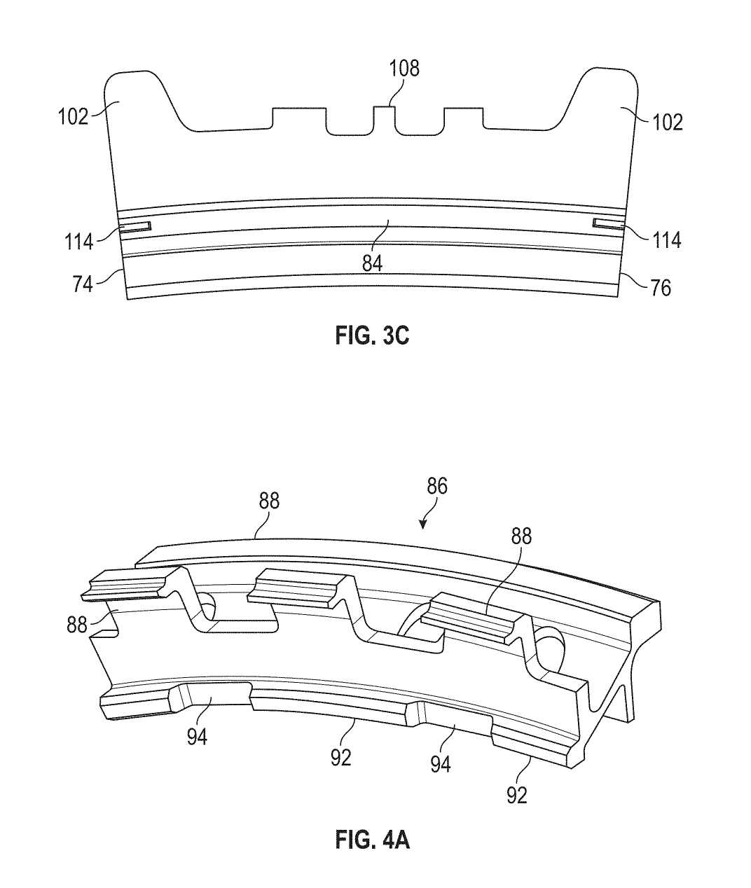

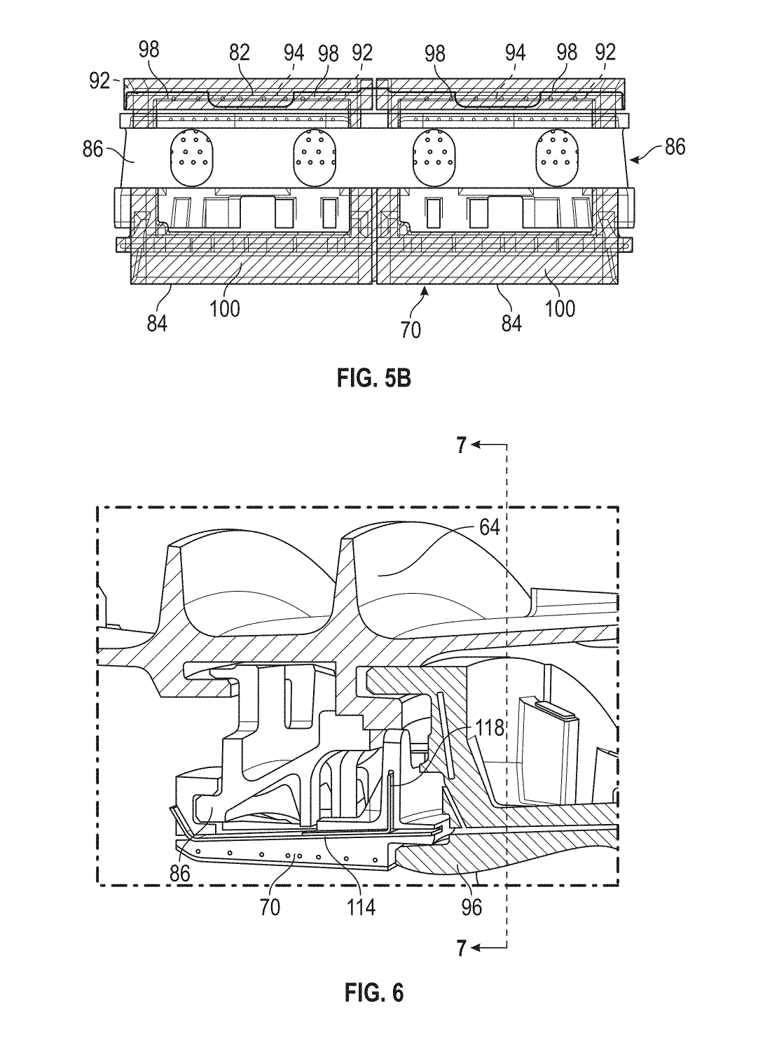

Referring at least to FIGS. 3B and 5A, the BOAS 70 includes a plurality of film cooling holes 73 for generating a film cooling air flow, the film cooling holes are disposed on surfaces exposed to the exhaust gasses 68. It should be understood that the term “holes” is used by way of description and not intended to limit the shape to a round opening. Accordingly, the example holes maybe round, oval, square or any other shape desired.

The BOAS 70 further includes a first side 74 and a second side 76. The first and second sides 74, 76 abut adjacent BOASs disposed circumferentially about the turbine case 64. Each of the BOASs 70 includes a forward end 78 and an aft end 80. The forward end 78 includes a hook portion 82 and the aft end 80 includes a continuous aft rail or hook 84 that extends between the first and second sides 74, 76 of the BOAS 70.

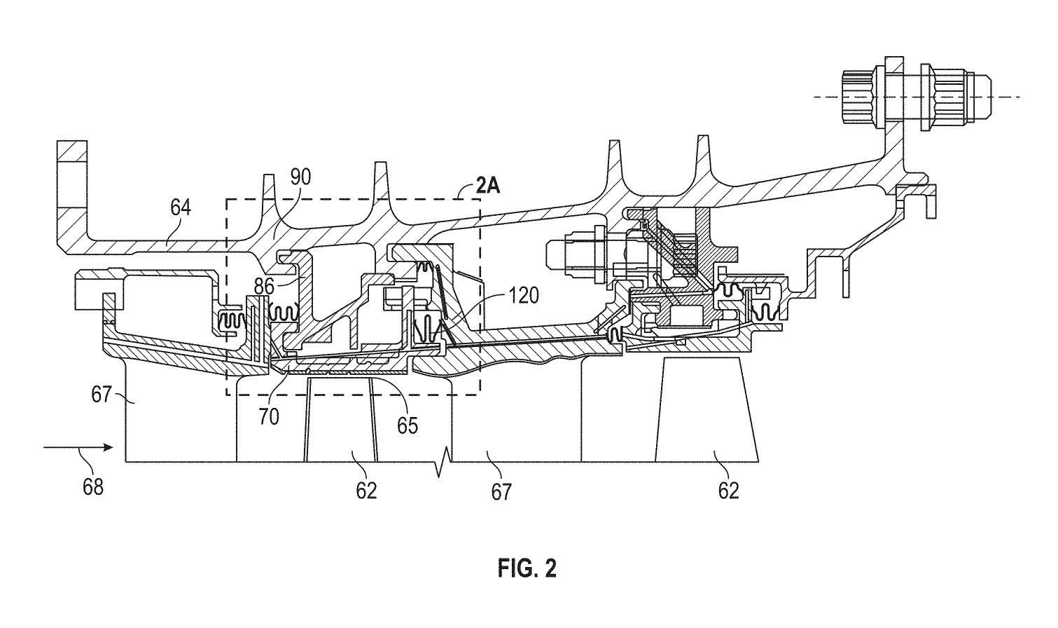

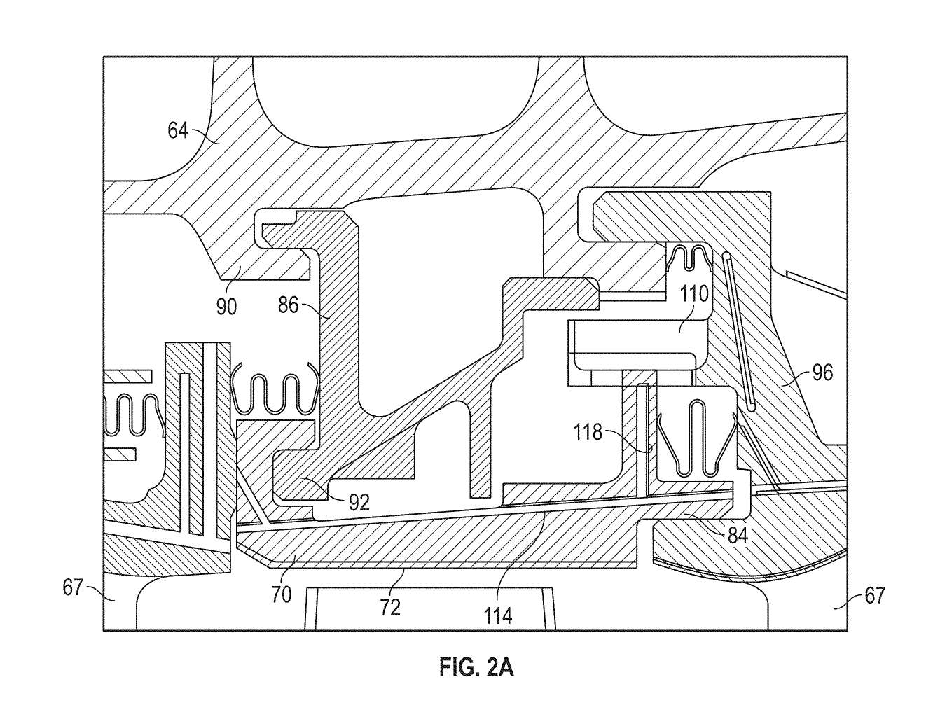

Referring now to FIGS. 2-7 and in order to secure the forward end 78 of the BOAS 70 to the turbine case 64, a BOAS support 86 is provided. The BOAS support 86 has a plurality of hook features 88 configured to engage complimentary features 90 of the turbine case 64. In addition, the BOAS support 86 has a front rail 92 that includes at least one scalloped feature 94 and in one embodiment a pair of scalloped features 94. In the embodiment where the blade outer air seal support 86 has a pair of scalloped features 94, the blade outer air seal support is configured to support at least two blade outer air seals 70 side by side.

The rail 92 is configured to engage the hook portion 82 when the BOAS 70 is secured to the BOAS support 86. By including the pair of scalloped features 94 in the front rail the BOAS 70 to BOAS support 86 has two points of contact between the forward end 78 of the BOAS 70 and the BOAS support 86. These two points of contact are identified as the interface between the hook 82 on opposite sides of one of the scalloped features 94.

At the opposite aft end 80, the continuous rail or hook 84 rests upon a portion of a vane platform 96 located aft of the BOAS 70. Since the rail or hook 84 is continuous a third point of contact is provided at the aft end 80 of the BOAS 70.

FIGS. 5A and 5B illustrate the BOAS 70 secured to the BOAS support 86. FIG. 5B is a view along lines 5B-5B of FIG. 5A although two adjacent BOAS 70 and a single BOAS support 86 are illustrated. The two points of contact between the forward end 78 of the BOAS 70 and the BOAS support 86 are illustrated by reference nos. 98 and the third point of contact between the aft end 80 of the BOAS 70 and the vane platform 96 is illustrated by reference no. 100. By providing 3 points of securement or contact the BOAS 70 is able to withstand uncurling in the engine due to high gas temperatures.

In addition, the BOAS 70 is also provided with a pair of ears 102 located proximate to opposite ends of the BOAS 70. In addition, gussets 104 are also provided to support the ears 102 and reduce vibrations. In addition, a pair of features 106 may be provided with the BOAS 70. In one embodiment these features 106 may extend from the gussets 104 and provide a guiding means for insertion of the BOAS 70 into the BOAS support 86. In addition, features 106 may temporarily hold the BOAS 70 in place during its assembly to the BOAS support 86. In another implementation, the feature 106 may assist in holding the feather seals in place. In yet another embodiment, a locating feature or features 108 may be provided on the aft end of the BOAS in order to locate or align the BOAS 70 with a vane lug or lug 110 of the vane platform 96 when the BOAS is secured to the vane platform 96. The feature 108 or features 108 also prevent the BOAS 70 from moving circumferentially once they are secured to the vane platform 96. As such, the feature 108 or features 108 provide an anti-rotation feature of the BOAS 70. In one embodiment, the feature or features 108 are located between the pair of ears 102.

FIG. 6 illustrates the BOAS 70 installed into the case 64 wherein the forward end 78 is supported by the BOAS support 86 and the aft end 80 is supported by the vane platform 96 of vane 67. As illustrated, the BOAS support 86 is secured to the BOAS 70 at one end and the case 64 at another end.

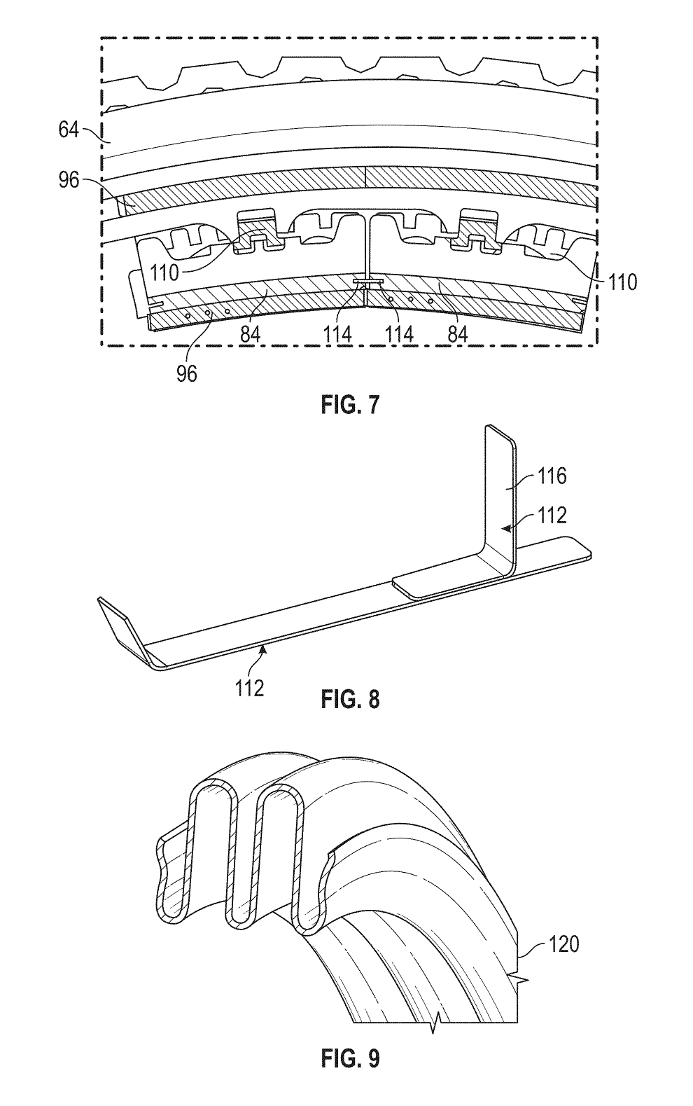

FIGS. 7 is view along lines 7-7 of FIG. 6 looking from aft forward. Here the vane lug or lug 110 of the vane platform 96 is illustrated engaging the features 108 of the BOAS 70. In addition, the continuous rail or hook 84 is illustrated resting upon a surface of the vane platform 96.

FIG. 8 illustrates feather seals 112 for receipt in cavities or grooves 114 of the BOAS 70. In one embodiment, one of the feather seals 112 has a vertical portion 116 that is received in a corresponding vertical groove 118 of BOAS 70. FIG. 9 illustrates a W seal 120 that is used in various embodiments of the present disclosure.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An assembly for use in a turbine section of a gas turbine engine, the assembly comprising:
a blade outer air seal having a forward end and opposite aft end and a pair of opposing sides extending between the forward end and the opposite aft end;
a blade outer air seal support, the blade outer air seal support having a rail with at least one scalloped opening, the rail engaging a hook located at the forward end of the blade outer air seal when the blade outer air seal is secured to the blade outer air seal support, wherein two points of contact are made between the hook and the rail of the blade outer air seal support when the blade outer air seal is secured to the blade outer air seal support; and
a vane platform, that receives and supports a rail of the blade outer air seal, the rail being located at the aft end of the blade outer air seal and the rail extends continuously between the pair of opposing sides of the blade outer air seal, wherein a single point of contact is made between the rail of the blade outer air seal and the vane platform when the blade outer air seal is secured to the vane platform.

2. The assembly as in claim 1, wherein the blade outer air seal support has a plurality of hook features that engage complimentary features of a turbine case.

3. The assembly as in claim 1, wherein the rail of the blade outer air seal support has a pair of scalloped features and is configured to support at least two blade outer air seals side by side.

4. The assembly as in claim 1, wherein the blade outer air seal has a pair of ears located proximate to the pair of opposing sides of the blade outer air seal.

5. The assembly as in claim 4, wherein the blade outer air seal has a pair of gussets to support the pair of ears and reduce vibrations in the blade outer air seal.

6. The assembly as in claim 5, wherein the blade outer air seal has a feature extending from the pair of gussets.

7. The assembly as in claim 1, wherein the blade outer air seal has a locating feature for aligning the blade outer air seal with a lug of the vane platform.

8. The assembly as in claim 1, further comprising feather seals for receipt in grooves located on the pair of opposing sides of the blade outer air seal.

9. The assembly as in claim 8, wherein one of the feather seals has a vertical portion that is received in a vertical groove of the grooves located on the pair of opposing sides of the blade outer air seal.

10. A gas turbine engine comprising:
a compressor section disposed about an axis;
a combustor in fluid communication with the compressor section;
a turbine section in fluid communication with the combustor, the turbine section includes at least one rotor having a plurality of rotating blades; and
a plurality of assemblies circumferentially surrounding the rotating blades, wherein at least one of the plurality of assemblies includes:
a blade outer air seal having a forward end and opposite aft end and a pair of opposing sides extending between the forward end and the opposite aft end;
a blade outer air seal support, the blade outer air seal support having a rail with at least one scalloped opening, the rail engaging a hook located at the forward end of the blade outer air seal when the blade outer air seal is secured to the blade outer air seal support, wherein two points of contact are made between the hook and the rail of the blade outer air seal support when the blade outer air seal is secured to the blade outer air seal support; and
a vane platform, that receives and supports a rail of the blade outer air seal, the rail being located at the aft end of the blade outer air seal and the rail extends continuously between the pair of opposing sides of the blade outer air seal, wherein a single point of contact is made between the rail of the blade outer air seal and the vane platform when the blade outer air seal is secured to the vane platform.

11. The gas turbine engine as in claim 10, wherein the blade outer air seal support has a plurality of hook features that engage complimentary features of a turbine case.

12. The gas turbine engine as in claim 10, wherein the rail of the blade outer air seal support has a pair of scalloped features and is configured to support at least two blade outer air seals side by side.

13. The gas turbine engine assembly as in claim 10, wherein the blade outer air seal has a pair of ears located proximate to the pair of opposing sides of the blade outer air seal.

14. The gas turbine engine as in claim 13, wherein the blade outer air seal has a pair of gussets to support the pair of ears and reduce vibrations in the blade outer air seal.

15. The gas turbine engine as in claim 14, wherein the blade outer air seal has a feature extending from the pair of gussets.

16. The gas turbine engine as in claim 10, wherein the blade outer air seal has a locating feature for aligning the blade outer air seal with a lug of the vane platform.

17. The gas turbine engine as in claim 10 further comprising feather seals for receipt in grooves located on the pair of opposing sides of the blade outer air seal.

18. The gas turbine engine as in claim 17, wherein one of the feather seals is has a vertical portion that is received in a vertical groove of the grooves located on the pair of opposing sides of the blade outer air seal.

19. A method of supporting a blade outer air seal of a gas turbine engine, the method comprising:
supporting a forward end of the blade outer air seal with a blade outer air seal support, the blade outer air seal support having a rail with at least one scalloped opening and the rail engages a hook located at the forward end of the blade outer air seal when the blade outer air seal is secured to the blade outer air seal support, wherein two points of contact are made between the hook of the blade outer air seal and the rail of the blade outer air seal support when the blade outer air seal is secured to the blade outer air seal support; and
supporting an opposite aft end of the blade outer air seal with a vane platform, wherein the vane platform receives and supports a rail of the blade outer air seal, the rail being located on an aft end of the blade outer air seal and extends continuously between a pair of opposing sides of the blade outer air seal, wherein a single point contact is made between the rail of the blade outer air seal and the vane platform when the blade outer air seal is secured to the vane platform.

20. The method as in claim 19, further comprising supporting the blade outer air seal support with a plurality of hook features that engage complimentary features of a turbine case.
